(19) United States
(12) Patent Application Publication
(10) Pub. No.: US 2009/0036639 A1
(43) Pub. Date: Feb. 5, 2009

(54) Post-Processing of Polylactic Acid Article

(75) Inventors: Qiuchen Peter Zhang, Alpharetta, GA (US); Michael O. Okoroafor, Roswell, GA (US); Xiaoyan Huang, Marietta, GA (US); Stuart Michael Ruan Jones, Melbourn (GB); Philip Andrew Dent, Newton (GB); Claire Louise Gould, Cambourne (GB)

Correspondence Address: SUTHERLAND ASBILL & BRENNAN LLP, 999 PEACHTREE STREET, N.E., ATLANTA, GA, 30309, US

(73) Assignee: The Coca-Cola Company, Atlanta, GA (US)

(21) Appl. No.: 12/181,415

(22) Filed: Jul. 29, 2008

Related U.S. Application Data
(60) Provisional application No. 60/952,925, filed on Jul. 31, 2007.

(51) Int. Cl. C08G 63/08

(52) U.S. Cl. 528/272

(57) ABSTRACT

Methods are provided for making a polylactic acid article. The methods may include the steps of providing an article comprising polylactic acid; supporting the article using a carrier support system; and curing the article with heat. The step of curing the article is effective to improve one or more properties of the article. Articles comprising polylactic acid also are provided having improved properties. Methods also are provided for preparing a beverage including the steps of providing a pod comprising polylactic acid, wherein the pod has been cured with heat while being supported by a carrier support system; placing a beverage material in the pod; placing a hot liquid into the pod; brewing the beverage material and hot liquid in the pod to create a beverage; and removing the beverage from the pod.

### FIELD OF THE INVENTION

The present invention relates to polylactic acid articles, and more particularly, to the post-processing of polylactic acid articles.

### BACKGROUND

Polylactic acid (PLA) materials are used in various articles such as biomedial structures, packaging, and textiles. Unfortunately, the use of PLA articles may be limited by their thermal properties, which may include softening at temperatures of about 60° C., and significant loss of mechanical rigidity at temperatures above about 85° C. As a result, conventional PLA articles may suffer from problems such as dimensional instability and mechanical failure when placed under high temperatures. What is desired, therefore, is an improved PLA article that exhibits both strength and structural stability at temperatures in a range from about 50° C. to about 105° C.

Strength and structural stability may be particularly important in applications such as coffee brewing. Coffee may be prepared by placing ground coffee within a pod structure and injecting water into the pod structure at temperatures of up to 100° C. and pressures of up to 11.5 bar. Unfortunately, the high temperatures and pressures of the brewing may limit the selection of the pod structure. In particular, the selection of the pod structure may be limited by the need for structural stability so as to ensure a water tight seal, and by the need for mechanical strength so as to withstand the application of pressure. What is desired, therefore, is a strong, thermally stable structure for coffee brewing.

### SUMMARY OF THE INVENTION

The present invention provides a method for making an article. In one exemplary embodiment, the method includes providing an article comprising polylactic acid; supporting the article using a carrier support system; and curing the article with heat.

The present invention also provides an article comprising polylactic acid. In an exemplary embodiment, the article has been cured with heat while being supported by a carrier support system.

The present invention also provides a method of preparing a beverage. In one exemplary embodiment, the method includes providing a pod comprising polylactic acid, wherein the pod has been cured with heat while being supported by a carrier support system; placing a beverage material in the pod; placing a hot liquid into the pod; brewing the beverage material and hot liquid in the pod to create a beverage; and removing the beverage from the pod.

The present invention also provides a method of increasing the thermal stability of a polylactic acid article. In one exemplary embodiment, the method includes providing an article comprising polylactic acid; supporting the article using a carrier support system; and curing the article with heat.

### BRIEF DESCRIPTION OF THE DRAWINGS

FIG. 1 shows a cross sectional view of one embodiment of the PLA pod.

FIG. 2 shows a bottom perspective view of one embodiment of the PLA pod.

FIG. 3 shows a cross sectional view of one embodiment of a support jacket.

FIG. 4 shows a side view of one embodiment of a support peg.

FIG. 5 shows a side view of one embodiment of a support peg with a metal with a metal core.

### DETAILED DESCRIPTION

Reference now will be made in detail to the presently preferred embodiments of the invention. Each example is provided by way of explanation of embodiments of the invention, not limitation of the invention. In fact, it will be apparent to those skilled in the art that various modifications and variations can be made in the present invention without departing from the spirit or scope of the invention. For instance, features illustrated or described as part of one embodiment can be used on another embodiment to yield a still further embodiment. Thus, it is intended that the present invention cover such modifications and variations within the scope of the appended claims and their equivalents.

Methods have been developed according to embodiments of this invention for making improved articles by curing a PLA article with heat while supporting the article using a carrier support system. Unlike conventional PLA articles, which may suffer from dimensional instability and mechanical failure when placed under high temperatures, the instant articles may sustain high temperatures and pressures while remaining substantially stable and functional. For example, the polylactic acid pods made in accordance with certain embodiments of this invention may sustain a coffee brewing cycle of 98° C. and 11.5 bar while retaining a high degree of dimensional stability. Furthermore, because the articles are supported with a carrier support system during the curing process, the improved articles may substantially retain their original dimensions. By maintaining the article's original dimensions, the support system ensures that the improved articles may be utilized in applications that require articles of a precise dimension. For example, polylactic acid pods made in accordance with certain embodiments of this invention have highly consistent internal volumes and can form highly consistent liquid tight seals.

As used herein, the terms “comprise,” “comprising,” “include,” and “including” are intended to be open, non-limiting terms, unless the contrary is expressly indicated.

### The Uncured Polylactic Acid Article

A process according to an embodiment of this invention can be used on essentially any polylactic acid article. As used herein, term “article” refers to any distinct physical object. According to certain embodiments, the article may be container such as a bag, bottle, cup, or lid. In other embodiments, the article may be a film or laminate. In still other embodiments, the article may be a food article such as a piece of tableware, tray, food package, or food wrap. In yet another embodiment, the article may be a fiber or textile used in applications such as upholstery, awnings, disposable garments, diapers, or female hygiene products. In yet another embodiment, the article may be a medical device such as a suture, stent, dialysis media, or drug delivery device.

The article may be constructed using essentially any techniques known in the art. In a certain embodiment, the PLA article is constructed by an injection molding process. In another embodiment, the PLA article is constructed by extrusion. In yet another embodiment, the PLA article is constructed by a thermoforming process. In yet another embodiment, the PLA article is constructed by a blow molding process.

According to certain embodiments, the article may be a polylactic acid pod. As used herein, the term “pod” refers to any three dimensional structure that may be filled or packed. The pod may comprise polylactic acid and, potentially, other thermoplastic materials and additives. The pod may be constructed using essentially any techniques known in the art.

The pod can be of essentially any shape or size. According to certain embodiments, the pod may be spherical, conical, cylindrical, or polyhedrous. In a certain embodiment, the pod is substantially cylindrical and has a volume ranging from about 0.1 ounces to about 50 ounces. In another embodiment, the pod has a volume ranging from about 5 ounces to about 20 ounces. In yet another embodiment, the pod has a volume ranging from about 0.5 ounces to about 1.5 ounces.

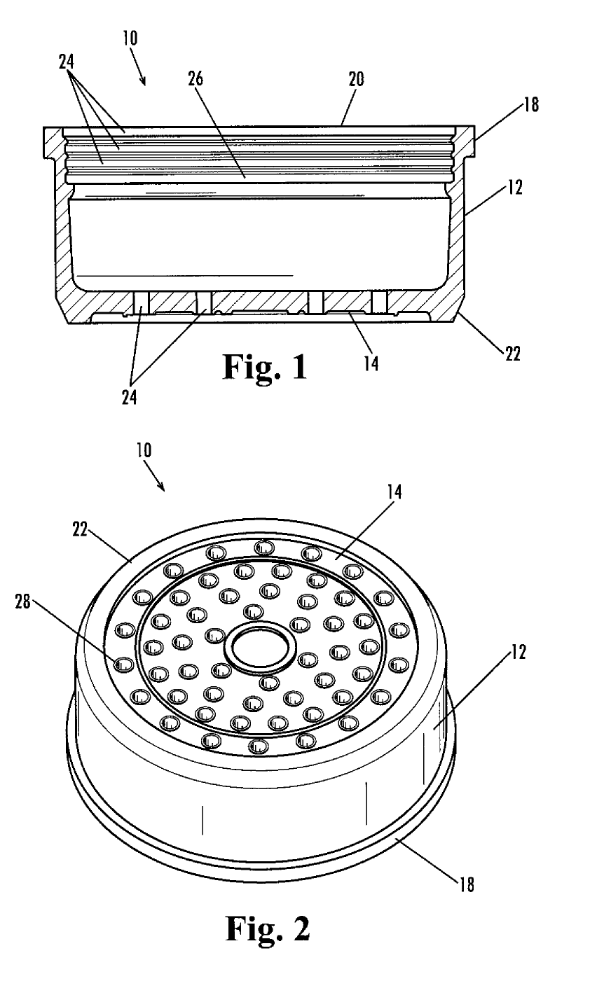

FIGS. 1-2 show one embodiment of a suitable PLA pod. The pod 10 may include a cylindrical body portion 12 and a substantially flat base portion 14 which define a reservoir 16. The pod 10 also may include an upper shoulder 18 which surrounds a reservoir opening 20, and a raised lip 22 which surrounds the base portion 14.

In order to accept a lid, the interior of the cylindrical body portion 12 may include one or more upper ridges 24, and a lower ridge 26. In order to remove liquid from the pod 10, the base portion 14 may include a plurality of holes 28.

### The Methods for Making the Improved Articles

Embodiments of this invention include methods of making articles comprising polylactic acid. In one embodiment, the method for making the article comprises providing an article comprising polylactic acid; supporting the article using a carrier support system; and curing the article with heat.

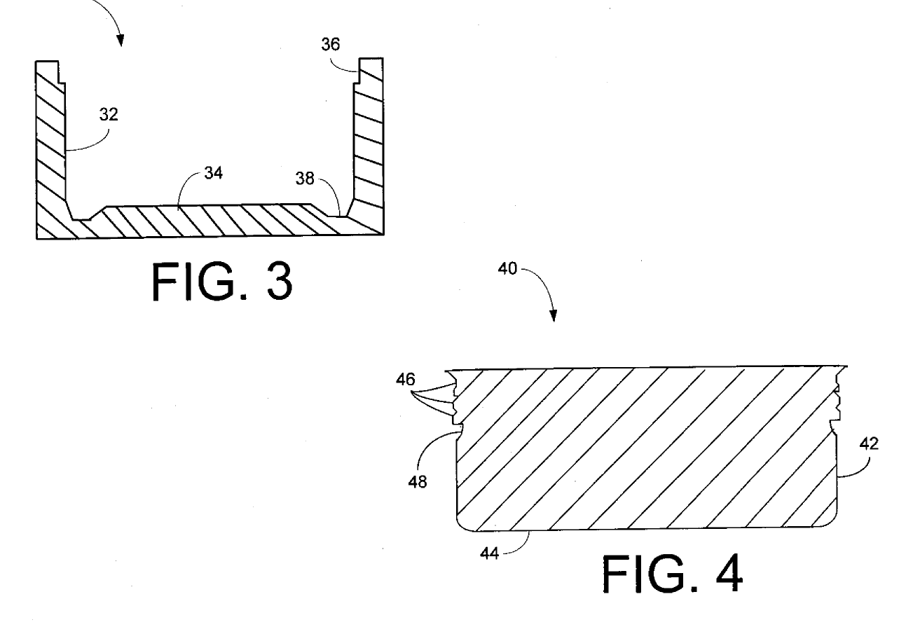

The methods for making the article include the step of supporting the article using a carrier support system. As used herein, the term “carrier support system” refers to a system that prevents at least a portion of the article from changing dimensions during the curing step. Non-limiting examples of carrier support systems include (1) support jackets that confine the outer portion of the articles, (2) support pegs that confine the inner portions of the articles, and (3) combinations of support jackets and support pegs. In certain embodiments, the carrier support system is used to support only a portion of the article. In other embodiments, the carrier support system is used to support substantially the entire article. The carrier support system jackets and/or pegs may be made of any suitable material. In certain embodiments, the carrier support system is made of a thermally conductive material that is dimensionally and thermally stable. Non-limiting examples of suitable support jacket materials include metals such as brass or steel. Non-limiting examples of suitable support peg materials include elastomeric materials such as rubber and silicon. In certain embodiments, the support peg includes thermally conductive pathways. For example, the support may comprise a silicon peg with a metal core that improves heat transfer and aids in the removal of the peg from improved article. FIGS. 3-5 show embodiments of a suitable support system for a polylactic acid pod.

The support system may include a support jacket 30 as shown in FIG. 3. The support jacket 30 may include a side portion 32 and a base portion 34. The support jacket 30 also may include an upper recess 36 and a lower recess 38. The support jacket 30 may accommodate the pod 10 so that the side portion 32 supports the exterior of the cylindrical body portion 12, the base portion 34 supports the exterior of the base portion 14, the upper recess 36 supports the upper shoulder 18, and the lower recess 38 supports the raised lip 22. As a result, the support jacket 30 may be used to support substantially all of the exterior of the pod.

The support system also may include a support peg 40 as shown in FIG. 4. The support peg 40 may include a side portion 42 and a bottom portion 44. The support peg 40 also may include one or more upper indentations 46 and a lower indentation 48. The support peg 40 may be inserted into the pod 10 so that the side portion 42 supports the interior of the cylindrical body portion 12, the bottom potion 44 supports the interior of the base portion 14, the one or more upper indentations 46 support the one or more upper ridges 24, and the lower indentation 48 supports lower ridge 26. As a result, the support jacket 30 may be used to support substantially the entire interior of the pod.

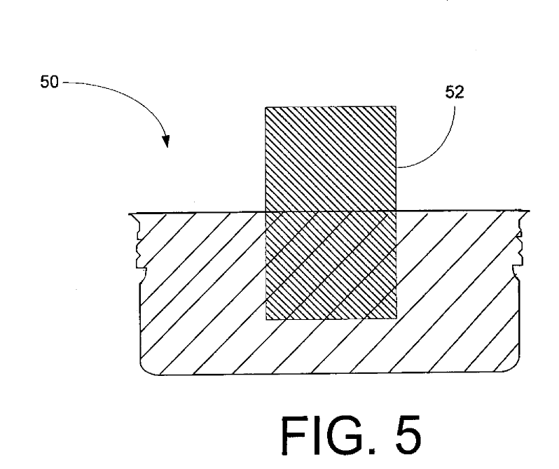

In another embodiment, the support system may include a support peg 50 as shown in FIG. 5. The support peg 50 may include a metal core 52 that improves heat transfer and aids in the removal of the support peg 50 from the pod.

The methods for making the article also include a curing step. As used herein, the terms “curing” and “cure” refer to the increase of crystallinity in the polylactic acid by heat setting or annealing, as well as other alterations that change one or more mechanical, physical and/or chemical properties of the PLA article relative to that of a non-cured article. Non-limiting examples of these properties include thermal stability, pressure stability, and dimensional stability.

The PLA article is treated with an amount of heat effective to cure the polylactic acid. In one embodiment, the curing process includes heating the PLA article to a temperature in a range from about 100° C. to about 140° C. for a time in a range from about 5 minutes to about 45 minutes. In another embodiment, the curing process includes heating the PLA article to a temperature in a range from about 110° C. to about 120° C. for a time in a range from about 10 minutes to about 20 minutes. Following the heat treatment, the PLA article optionally may be flash cooled to a low temperature. In one embodiment, the flash cooling includes cooling the PLA article to a temperature of about −15° C. for a time in a range from about 1 minute to about 10 minutes. In a particular embodiment, the heating is conducted at a temperature of about 110° C. for about 10 minutes.

### The Improved Polylactic Acid Pods

Also embodied in this invention are articles comprising polylactic acid. In one embodiment, the article has been cured with heat while being supported by a carrier support system. As a result of the curing process, the article may have at least one mechanical, physical, and/or chemical property increased relative to that of an uncured article of the same construction. For example, the article may have increased crystallinity, increased thermal stability, increased pressure stability, or increased dimensional stability relative to that of a non-cured pod of the same construction.

According to certain embodiments, the article may be a polylactic acid pod. In a particular embodiment, the pod is substantially cylindrical and has a volume in a range from about 0.1 ounces to about 50 ounces. In another embodiment, the pod has a volume in a range from about 5 ounces to about 20 ounces. In yet another embodiment, the pod has a volume in a range from about 0.5 ounces to about 1.5 ounces.

### The Methods of Preparing a Beverage

Also embodied in this invention are methods of preparing beverages with pods comprising polylactic acid. In one embodiment, the method of preparing the beverage comprises providing a pod comprising polylactic acid, wherein the pod has been cured with heat while being supported by a carrier support system; placing a beverage material in the pod; placing a hot liquid into the pod; brewing the beverage material and hot liquid in the pod to create a beverage; and removing the beverage from the pod. In one embodiment, the beverage material comprises coffee or tea grounds.

The brewing step may include brewing at a temperature in a range from about 85° C. to about 100° C. and at a pressure in a range from about 6 bar to about 12 bar. In one embodiment, the method further comprises the step of sealing the pod after the step of placing the beverage material into the pod and before the step of placing the hot liquid in the pod. In another embodiment, the method further comprises the step of placing the pod in a beverage brewing machine after the step of placing the beverage material into the pod and before the step of placing the hot liquid in the pod.

The methods and pods described above will be further understood with reference to the following non-limiting examples.

### EXAMPLE 1

### Effect of Curing Time and Temperature on Pod Strength

Polylactic acid pods were placed in a brass jacket with no insert. The pods were then cured with heat for a variety of temperatures and times. After the pods had cooled, they were re-heated and tested on an Instron testing machine (Norwood, Mass.) to determine their peak load capacity at 100° C. as compared to non-cured pods of similar construction.

The curing time, curing temperature, cooling method, and peak load capacity of the pods are summarized in the following table:

TABLE 1
Effect of Curing Time and Temperature on Peak Load Capacity

| Sample | Temperature | Time | Cooling | Peak |
|---|---|---|---|---|
| No. | (° C.) | (min) | Method | Load (N) |
| 1 | Non-Cured Control | | | 54.81 |
| 2 | Non-Cured Control | | | 46.86 |
| 3 | Non-Cured Control | | | 60.13 |
| 4 | 100 | 15 | Ambient Cooled | 480.86 |
| 5 | 100 | 15 | Ambient Cooled | 540.90 |
| 6 | 100 | 15 | Ambient Cooled | 395.80 |
| 7 | 100 | 20 | Ambient Cooled | 542.31 |
| 8 | 100 | 20 | Ambient Cooled | 615.93 |
| 9 | 100 | 20 | Ambient Cooled | 614.88 |
| 10 | 110 | 8 | Ambient Cooled | 331.06 |
| 11 | 110 | 10 | Ambient Cooled | 658.77 |
| 12 | 110 | 10 | Ambient Cooled | 566.82 |
| 13 | 110 | 10 | Ambient Cooled | 634.40 |
| 14 | 110 | 10 | 10 min at −15° C. | 556.65 |
| 15 | 110 | 10 | 10 min at −15° C. | 539.66 |
| 16 | 110 | 10 | 10 min at −15° C. | 633.27 |
| 17 | 120 | 6.5 | Ambient Cooled | 206.44 |
| 18 | 120 | 8 | Ambient Cooled | 531.25 |

As shown in Table 1, the peak load capacity of the pods was significantly improved as compared to the non-cured pods of similar construction.

### EXAMPLE 2

### Effect of Curing on Crystallinity

Polylactic acid pods were placed in a brass jacket with no insert and cured at 110° C. for 20 minutes. After the pods had cooled, three samples of PLA were removed from the center of the base portion of the cured pods. In addition, one sample of PLA was removed from the center of the base portion of an uncured pod. Differential scanning calorimetry (DSC) testing was then performed on each of the samples at a rate of 10° C. per minute. Crystallinity was then calculated for each of the samples using the DSC curves.

The curing treatment and crystallinity of the pods are summarized in the following table:

TABLE 2
Effect of Curing on Crystallinity

| Sample No. | Treatment | Crystallinity |
|---|---|---|
| 1 | Non-Cured Control | 1% |
| 2 | Cured at 110° C. for 20 Minutes | 48% |
| 3 | Cured at 110° C. for 20 Minutes | 49% |
| 4 | Cured at 110° C. for 20 Minutes | 49% |

As shown in Table 2, the crystallinity of the pods was significantly improved as compared to the non-cured pods of similar construction.

While the invention has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereof.

What is claimed is:

1. A method for making an article, comprising:
providing an article comprising polylactic acid;
supporting the article using a carrier support system; and
curing the article with heat.

2. The method of claim 1, wherein the step of curing the article comprises increasing the crystallinity of the polylactic acid.

3. The method of claim 1, wherein the step of curing the article comprises increasing the thermal stability of the article.

4. The method of claim 1, wherein the step of curing the article comprises increasing the pressure stability of the article.

5. The method of claim 1, wherein the step of curing the article comprises increasing the dimensional stability of the article.

6. The method of claim 1, wherein the step of curing the article comprises heating the article to a temperature in a range from about 100° C. to about 140° C.

7. The method of claim 1, wherein the step of curing the article comprises heating the article for a time in a range from about 5 minutes to about 45 minutes.

8. The method of claim 1, wherein the step of curing the article comprises heating the pod at a temperature in a range from about 100° C. to about 110° C. for a time in a range from about 10 minutes to about 20 minutes.

9. The method of claim 1, wherein the step of supporting the article comprises placing the article in a support jacket.

10. The method of claim 9, wherein the support jacket comprises a thermally conductive material that is dimensionally and thermally stable.

11. The method of claim 9, wherein the support jacket comprises a metal.

12. The method of claim 1, wherein the step of supporting the article comprises inserting a support peg into the article.

13. The method of claim 12, wherein the support peg comprises an elastomeric material.

14. The method of claim 12, wherein the support peg comprises silicon.

15. The method of claim 12, wherein the support peg further comprises a thermally conductive pathway.

16. The method of claim 15, wherein the thermally conductive pathway comprises a metal core.

17. The method of claim 1, wherein the step of supporting the article comprises placing the pod in a support jacket and inserting a support peg into the article.

18. The method of claim 1, wherein the article comprises a polylactic acid pod.

19. An article comprising polylactic acid, wherein the article has been cured with heat while being supported by a carrier support system.

20. The article of claim 19, wherein the article has increased crystallinity relative to that of a non-cured article of the same construction.

21. The article of claim 19, wherein the article has increased thermal stability relative to that of a non-cured article of the same construction.

22. The article of claim 19, wherein the article has increased pressure stability relative to that of a non-cured article of the same construction.

23. The article of claim 19, wherein the article has increased dimensional stability relative to that of a non-cured article of the same construction.

24. The article of claim 19, wherein the article comprises a polylactic acid pod.

25. The article of claim 24, wherein the pod has a volume in a range from about 0.1 ounces to about 50 ounces.

26. The article of claim 24, wherein the pod has a volume in a range from about 5 ounces to about 20 ounces.

27. The article of claim 24, wherein the pod has a volume in a range from about 0.5 ounces to about 1.5 ounces.

28. A method of preparing a beverage, comprising:
providing a pod comprising polylactic acid, wherein the pod has been cured with heat while being supported by a carrier support system;
placing a beverage material in the pod;
placing a hot liquid into the pod;
brewing the beverage material and hot liquid in the pod to create a beverage; and
removing the beverage from the pod.

29. The method of claim 28, wherein the beverage material comprises coffee or tea grounds.

30. The method of claim 28, wherein the step of brewing comprises brewing at a temperature in a range from about 85° C. to about 100° C.

31. The method of claim 28, wherein the step of brewing comprises brewing at a pressure in a range from about 6 bar to about 12 bar.

32. The method of claim 28, wherein the step of brewing comprises brewing at a temperature in a range from about 85° C. to about 100° C. and a pressure in a range from about 6 bar to about 12 bar.

33. The method of claim 28, further comprising the step of sealing the pod after the step of placing the beverage material into the pod and before the step of placing the hot liquid in the pod.

34. The method of claim 28, further comprising the step of placing the pod in a beverage brewing machine after the step of placing a beverage material in the pod and before the step of placing the hot liquid in the pod.

35. A method of increasing the thermal stability of a polylactic acid article, comprising:
providing an article comprising polylactic acid;
supporting the article using a carrier support system; and
curing the article with heat.

36. The method of claim 35, wherein the step of curing the article comprises heating the article to a temperature in a range from about 100° C. to about 140° C.

37. The method of claim 35, wherein the step of curing the article comprises heating the article for a time in a range from about 5 minutes to about 45 minutes.

38. The method of claim 35, wherein the step of curing the article comprises heating the pod at a temperature in a range from about 100° C. to about 140° C. for a time in a range from about 5 minutes to about 45 minutes.

39. The method of claim 35, wherein the step of curing the article comprises heating the pod at a temperature in a range from about 100° C. to about 110° C. for a time in a range from about 10 minutes to about 20 minutes.
